(19) United States
(12) Patent Application Publication
(10) Pub. No.: US 2015/0264771 A1
(43) Pub. Date: Sep. 17, 2015

(54) METHOD OF DRIVING LED CHIP

(71) Applicants: MING-FENG LIN, (US); HEP TECH CO., LTD., Taichung (TW)

(72) Inventor: MING-FENG LIN, Taichung (TW)

(73) Assignees: HEP TECH CO., LTD., Taichung (TW); MING-FENG LIN, Taichung (TW)

(21) Appl. No.: 14/641,350

(22) Filed: Mar. 7, 2015

(30) Foreign Application Priority Data
Mar. 14, 2014 (TW) 103109678

(51) Int. Cl. H05B 33/08

(52) U.S. Cl. CPC H05B 33/0851; H05B 33/0815

(57) ABSTRACT

A method of driving a LED chip includes the following steps: generate a reference voltage, and accordingly control a driving unit to output electrical energy at a power corresponding to the strength of the reference voltage; obtain an operating current required by the LED chip; control the driving unit to output the operating current to the LED chip under the power corresponding to the reference voltage. Whereby, with different strengths of the reference voltage, the driving unit is capable of outputting electrical energy to the LED chip at different powers. Therefore, one single driving apparatus applied with the method is sufficient to replace multiple conventional driving apparatuses for LED chips.

### BACKGROUND OF THE INVENTION

1. Technical Field

The present invention relates generally to driving a LED chip, and more particularly to a method of driving a led chip.

2. Description of Related Art

Typically, a LED (light-emitting diode) device includes a LED chip and a driving apparatus, wherein the driving apparatus provides electrical energy to the LED chip. There are various types of LED chips in the current market, and LED chips with different specifications may require different rated voltages and rated currents, even for those compatible with the same power. For example, a LED chip compatible with 28 W may have the following combinations of rated voltages and rated currents: 80V/350 mA, 56V/500 mA, 40V/700 mA, etc. Not to mention those LED chips compatible with different powers, for apparently there must be a lot more combinations of rated voltages and rated currents.

Conventionally, one specific type of driving apparatus can only drive LED chips with one specific specification. Since there are all kinds of LED chips with different specifications, the inventory pressure for driving apparatuses is usually high for manufacturers. If a manufacturer has to produce several types of driving apparatuses in order to drive LED chips with different specifications, the quantities of each type of driving apparatuses is limited. Therefore, the price and the manufacturing cost are unlikely to be lowered, and that's why LED lighting appliances are more expensive than conventional kinds, which hinders such appliances from being further accepted by customers. In light of this, it would be preferable to have one type of driving apparatus which is capable of driving LED chips compatible with different powers and even with different combinations of rated voltages and rated currents, for the inventory pressure would be effectively relieved, and the manufacturing cost would be greatly reduced as well.

### BRIEF SUMMARY OF THE INVENTION

In view of the above, the primary objective of the present invention is to provide a method of driving a led chip, wherein the method is capable of driving LED chips requiring different powers and different combinations of rated voltages and rated currents.

The method of driving a led chip provided in the present invention is applied on a driving apparatus, which has a driving unit electrically connected to a LED chip, wherein the driving unit is controllable to provide electrical energy at one of a plurality of powers to the LED chip. The method includes the following steps: (a) generate a reference voltage, and accordingly control the driving unit to output electrical energy at a power corresponding to the reference voltage; (b) obtain an operating current required by the LED chip; (c) control the driving unit to output the operating current to the LED chip under the power corresponding to the reference voltage.

Whereby, the driving unit provides electrical energy at different powers to the LED chip according to different strengths of the reference voltage. The method effectively lightens the inconvenience caused by the conventional way that one type of driving apparatus can only drive LED chips with the same specification.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of the driving apparatus applied with a first preferred embodiment of the present invention;

FIG. 2 is a circuit, showing an embodiment of the bleeder resistance circuit of the driving apparatus applied with the first preferred embodiment of the present invention;

FIG. 3 is a flow chart showing the first preferred embodiment of the present invention; and

FIG. 4 is a block diagram of the driving apparatus applied with a second preferred embodiment of the present invention.

### DETAILED DESCRIPTION OF THE INVENTION

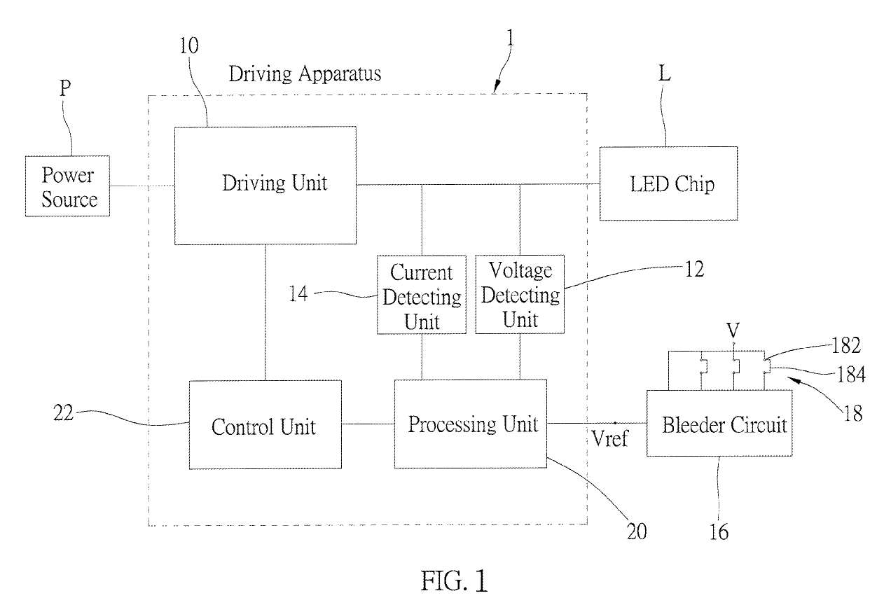

As shown in FIG. 1, a driving apparatus 1 suitable for applying the first preferred embodiment of the present invention includes a driving unit 10, a voltage detecting unit 12, a current detecting unit 14, a bleeder circuit 16, a plurality of switches 18, a processing unit 20, and a control unit 22.

The driving unit 10 is electrically connected to a power source P and a LED chip L. The driving unit 10 converts electrical energy provided by the power source P into an operating voltage and an operating current which are required by the LED chip L, and outputs the operating voltage and the operating current. The driving unit 10 can be controlled to provide electrical energy at one of a plurality of different powers. Furthermore, while providing electrical energy at one of the powers, the driving unit 10 is also controllable to change the operating current and the operating voltage. In practice, the driving unit 10 can be designed based on PWM, half-bridge, buck, or boost circuits.

The voltage detecting unit 20 is electrically connected to the driving unit 10 to detect the operating voltage provided to the LED chip L by the driving unit 10. The current detecting unit 14 is also electrically connected to the driving unit 10 to detect the operating current provided to the LED chip L by the driving unit 10.

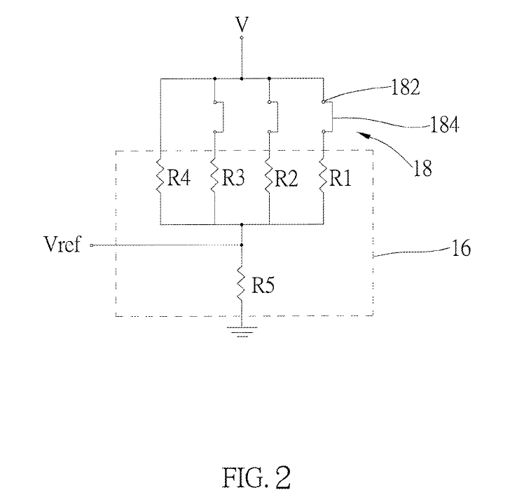

For applying the first preferred embodiment, the bleeder circuit 16 is a bleeder resistance circuit electrically connected to the switches 18, which are electrically connected to a voltage source V; each of the switches 18 includes two pins 182 and a jumper 184, wherein the pins 182 are, respectively, electrically connected to the voltage source V and the bleeder circuit 16, while the jumper 184 is detachably connected to the pins 182 to make the relevant switch 18 in either open state (switched off) or short-circuit condition (switched on). The voltage provided from the voltage source V is divided by the bleeder circuit 16 to generate a reference voltage Vref. As shown in FIG. 2, the bleeder circuit 16 for applying the first preferred embodiment includes a plurality of resistors R1-R4, which are connected in parallel, and a resistor R5 connected to the resistors R1-R4 in series,. The resistors R1-R3 are connected to the voltage source V through one the switches 18, while the resistor R4 is directly connected to the voltage source V. The resistors R1-R4 are grounded through the resistor R5. Whereby, the divided voltage on the resistor R5 is the reference voltage.

The on/off statuses of the switches 18 construct a plurality of combinations. More specifically, given the number of the switches 18 is n, the number of the combinations of on/off statuses is 2ⁿ. For example, the number of the combinations for three switches 18 is eight (2³). The resistors R1-R4 have different resistances, and with correspondence to different combinations constructed by the switches 18, the resistors R1-R4 can be together seen as equivalent resistors having different resistances. In other words, by connecting or disconnecting the jumpers 184 of the switches 18 to the corresponding pins 182, the equivalent resistor formed in the bleeder circuit 16 can have one out of eight different resistances. As a result, the bleeder circuit 16 is capable of outputting the reference voltage of one out of eight different strengths. In practice, the reference voltage can be generated in different ways, such as using a variable resistor to divide the voltage provided by the voltage source V, or using a microprocessor to output voltage of different strengths.

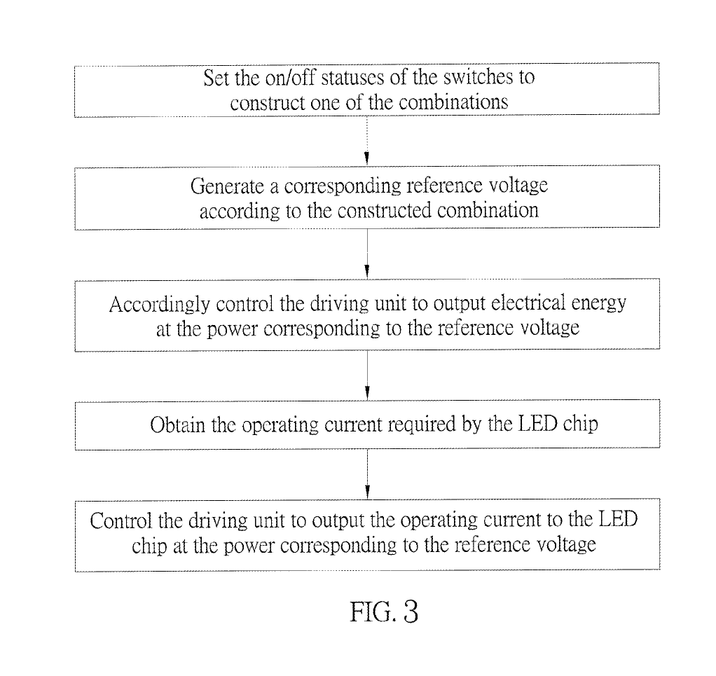

The processing unit 20 is electrically connected to the voltage detecting unit 12, the current detecting unit 14, and the bleeder circuit 16. Also, the processing unit 20 is electrically connected to the driving unit 10 through the control unit 22. The processing unit 20 transmits a current control signal to the driving unit 10 through the control unit 50 according to the strength of the reference voltage Vref, which controls the driving unit 10 to provide electrical energy at the power corresponding to the reference voltage Vref. Specifically, the power of the electrical energy provided by the driving unit 10 is direct proportional to the reference voltage Vref. For instance, the value of the power of the electrical energy provided by the driving unit 10 can be any positive integer between 28 W and 21 W, wherein the highest reference voltage Vref corresponds to 28 W, the second highest reference voltage Vref corresponds to 27 W, and so on. In addition, the processing unit 20 further processes the detection results of the voltage detecting unit 12 and the current detecting unit 14, and controls the driving unit 10 through the control unit 22 correspondingly. As a result, the driving unit 10 can output the operating current required by the LED chip L under the power corresponding to the reference voltage Vref.

Whereby, a method of driving a led chip can be applied on the aforementioned driving apparatus 1 includes the following steps as shown in FIG. 3:

First of all, select one combination among the 2ⁿ combinations of the on/off statuses of the switches 18 according to the specification of the LED chip L to make the driving unit 10 provide electrical energy at the corresponding power which meets the specification of the LED chip L. For example, given the driving unit 10 is able to provide electrical energy at power between 28 W and 21 W, and the LED chip L requires 28 W for operation, all of the three jumpers 184 should be all connected to the corresponding pins 182, which provides a minimum equivalent resistance due to the resistors R1-R4 are connected in parallel, and therefore the resistor R5 is provided with a maximum possible divided voltage from the voltage source V. In this way, the processing unit 20 outputs the highest possible reference voltage to control the driving unit 10 through the control unit 22, and therefore the driving unit 10 provides electrical energy at power of 28 W.

And then, the processing unit 20 controls the driving unit 10 through the control unit 22 to gradually intensify the current provided to the LED chip L from a weaker intensity. At the same time, the processing unit 20 calculates the product of the voltage and the current (i.e., the power) detected by the voltage detecting unit 12 and the current detecting unit 14. It is easily understood that the voltage provided to the LED chip L increases along with the current provided to the driving unit 10, and the power provided to the LED chip L also consequently increases. The current is stopped being intensified once the power provided to the LED chip L reaches the power corresponding to the reference voltage, which is 28 W in this example. The current provide to the LED chip L at this time point is the operating current required when the LED chip L is operated at the power corresponding to the reference voltage.

After that, the processing unit 20 continuously controls the driving unit 10 through the control unit 22 to maintain the power at an intensity corresponding to the reference voltage.

If the LED chip L is replaced by another LED chip which requires power of 27 W, one of the jumpers 184 should be disconnected to the corresponding pins 182, which lowers the reference voltage, and the driving unit 10 can be controlled to provide electricity energy at 27 W in the same way as described above. Similarly, when all of the jumpers 184 are disconnected to the corresponding pins 182, the resistors R1-R4 provide the maximum possible equivalent resistance, which makes the divided voltage on the resistor R5 as minimum, whereby the driving unit 10 outputs the lowest possible reference voltage which corresponds to the power of 21 W. For the preferred embodiment, the cost of parts can be effectively lowered by using the switches 18 including the jumpers 184 and the pins 182.

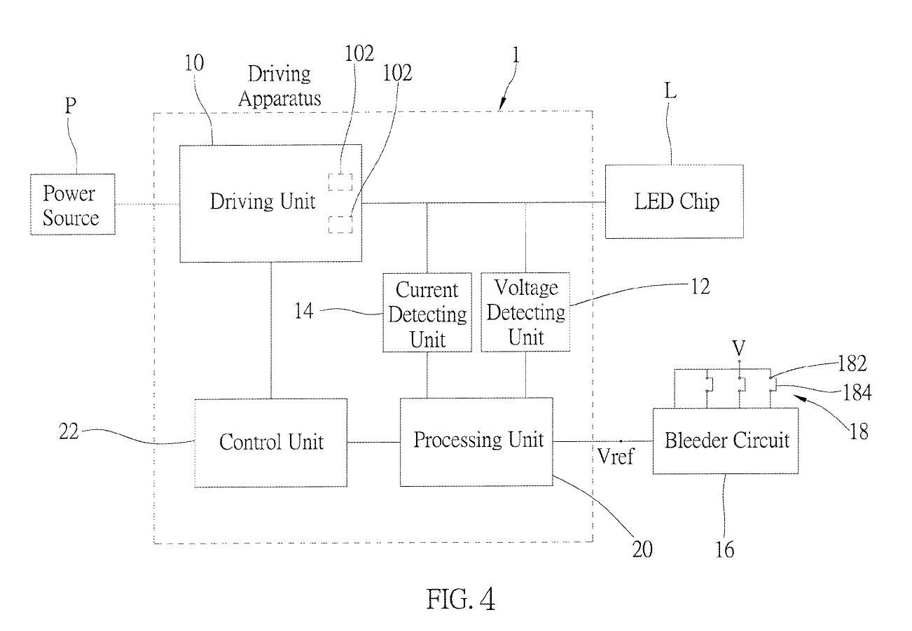

For the second preferred embodiment, the driving unit 10 includes a plurality of current output circuit 102 as shown in FIG. 4. Each of the current output circuit 102 outputs current within a predetermined range, wherein the predetermined range for the current output circuits 102 are different from each other. The processing unit 20 controls the driving unit 10 through the control unit 22, wherein the driving unit 10 outputs the operating current required by the LED chip L under the power corresponding to the reference voltage with the corresponding current output circuit 102. For example, if the required operating current is 600 mA, the driving unit 10 outputs the operating current with the current output circuit 102 of which the predetermined range is 500-700 mA. In this way, the driving unit 10 is capable of outputting current with a wider range, and therefore the driving apparatus 1 is compatible with more types of LED chips.

In summary, the reference voltage of different strengths can be generated by changing the combinations of the on/off statuses of the switches 18, and the driving unit can be controlled to output electrical energy at different powers correspondingly. As a result, one single driving apparatus 1 is just sufficient to replace multiple conventional driving apparatuses which provide electrical energy at different powers, which effectively lightens the inconvenience caused by the conventional way that one driving apparatus can only drive LED chips with the same specification.

It must be pointed out that the embodiments described above are only some preferred embodiments of the present invention. All equivalent methods which employ the concepts disclosed in this specification and the appended claims should fall within the scope of the present invention.

What is claimed is:

1. A method of driving a led chip, which is applied on a driving apparatus having a driving unit electrically connected to a LED chip, wherein the driving unit is controllable to provide electrical energy at one of a plurality of powers to the LED chip; comprising the steps of:
(a) generating a reference voltage, and accordingly controlling the driving unit to output electrical energy at a power corresponding to the reference voltage;
(b) obtaining an operating current required by the LED chip;
(c) controlling the driving unit to output the operating current to the LED chip under the power corresponding to the reference voltage.

2. The method of claim 1, wherein the driving unit includes a plurality of current output circuits, each of the current output circuit outputs current within a predetermined range, and the predetermined range for the current output circuits are different from each other;
the driving unit is controlled to output the operating current to the LED chip under the power corresponding to the reference voltage with the corresponding current output circuit in step (c).

3. The method of claim 1, wherein the power of the electrical energy outputted by the driving unit is direct proportional to the strength of the reference voltage.

4. The method of claim 1, wherein the reference voltage is generated by dividing voltage provided by a voltage source with a bleeder circuit in step (a).

5. The method of claim 4, wherein the bleeder circuit is electrically connected to a plurality of switches; the reference voltage is generated by switching on/off statuses of the switches in step (a).

6. The method of claim 4, wherein the bleeder circuit includes a bleeder resistance circuit electrically connected to a plurality of switches; the voltage provided by the voltage source is divided to generate the reference voltage by switching on/off statuses of the switches, which makes the bleeder resistance circuit provide an equivalent resistance.

7. The method of claim 6, wherein the number of the switches is n, and the on/off statuses of the switches construct 2ⁿ combinations; the on/off statuses of the switches are set as one out of the 2ⁿ combinations in step (a), which makes the equivalent resistance provided by the bleeder resistance circuit as one out of 2ⁿ resistances.

8. The method of claim 7, wherein each of the switch includes two pins and a jumper;
the pins are electrically connected to the voltage source and the bleeder resistance circuit, and the jumper is detachably connected to the pins; each of the combinations is constructed by connecting or disconnecting the jumper of each switch to the corresponding pins.
